(19) United States
(12) Patent Application Publication
(10) Pub. No.: US 2026/0153436 A1
(43) Pub. Date: Jun. 4, 2026

(54) SPECTROMETER, MODULE AND METHOD FOR CORRECTING MISALIGNMENT OF A LASER BEAM WITH A LENS' OPTICAL AXIS

(71) Applicant: Renishaw plc, Wotton-under-Edge, Gloucestershire (GB)

(72) Inventors: Brian John Edward SMITH, Wotton-under-Edge (GB); James Roderick PARKER, Wotton-under-Edge (GB)

(73) Assignee: Renishaw plc, Wotton-under-Edge, Gloucestershire (GB)

(21) Appl. No.: 19/512,743

(22) PCT Filed: Aug. 22, 2024
(86) PCT No.: PCT/GB2024/052203

§ 371 Date: Feb. 20, 2026

(30) Foreign Application Priority Data
Aug. 24, 2023 (GB) 2312918.2

(51) Int. Cl. G01N 21/31; G01B 11/27

(52) U.S. Cl. CPC G01N 21/31; G01B 11/272; G01N 2201/06113; G01N 2201/0636

(57) ABSTRACT

A spectrometer including a laser for generating a laser beam, a lens for directing the laser beam to a location of a sample, and a component for directing the laser beam to the lens so as to be co-axial with the lens' optical axis, the spectrometer including a beam splitter for directing the part of the laser beam towards a sensor arranged such that part of the laser beam can be used for monitoring alignment of the laser beam with the lens' optical axis, and wherein the spectrometer comprises a laser beam path correction element. Optionally the spectrometer includes an element for directing the part of the laser beam towards a sensor.

The invention of the current application relates to a spectrometer, module for a spectrometer and a method.

WO 92/22793 A1 discloses a spectrometer, in particular a Raman spectrometer. an input laser beam 10 that is reflected through 90° by a dichroic filter 12. The laser beam 10 then passes to an objective lens 16, which focuses the laser beam to a spot at a focal point 19 on a sample 18.

At installation, components of the spectrometer are set up so that after reflection by the dichroic filter 12 the laser beam 10 is co-axial and parallel with the optical axis of the objective lens 16.

According to a first aspect of invention there is provided a spectrometer comprising a laser for generating a laser beam, a lens for directing the laser beam to a location of a sample, and a component for directing the laser beam to the lens so as to be co-axial with the lens' optical axis, the spectrometer comprising a beam splitter for directing the part of the laser beam towards a sensor arranged such that part of the laser beam can be used for monitoring alignment of the laser beam with the lens' optical axis, and wherein the spectrometer comprises a laser beam path correction element. Optionally the laser beam path correction element is located between the beam splitter and the lens The part of the laser beam used for monitoring alignment may be less than the whole laser beam. The beam splitter for directing the part of the laser beam towards a sensor may be movable between a first position where the beam splitter for directing the part of the laser beam towards a sensor is in the path of the laser beam and a second position where the beam splitter for directing the part of the laser beam towards a sensor is not in the path of the laser beam. Optionally the laser path correction element can be moved between a first position where the laser beam path correction element is in the path of the laser beam and a second position where the laser beam path correction element is not in the path of the laser beam. Optionally the beam splitter and the laser path correction element can be moved in tandem between the first position and the second position.

The spectrometer may comprise a second beam splitter for splitting the part of the laser beam such that a first part is directed towards the sensor and a second part is directed towards a second sensor where the path length of the laser beam between the component and the sensor, and path length of the laser beam between the component and the second sensor are different. Monitoring alignment of the laser beam with the lens' optical axis may comprise monitoring the location of the laser beam on the component. Optionally monitoring alignment of the laser beam with the lens' optical axis comprises monitoring the direction of the laser beam towards the component (i.e., the direction of the laser beam before reflection towards the lens) and/or the direction away from the component (i.e., the direction of the laser beam after reflection towards the lens). The spectrometer may be configured to reduce misalignment of the laser beam with the lens' optical axis based on the monitoring. The spectrometer may comprise a first beam path director movable in two degrees of freedom, wherein the first beam path director is controlled to reduce misalignment of the laser beam with the lens' optical axis based on the monitoring. Optionally the first beam path director is in the laser beam path and may be located before the component for directing the laser beam to the lens. Optionally the spectrometer may comprise a second beam path director movable in two degrees of freedom. The second beam path director may be controlled to reduce misalignment of the laser beam with the lens' optical axis based on the monitoring. Optionally the first beam path director and/or the second beam path director is a mirror.

By providing a spectrometer that can monitor the alignment of a laser beam with the optical axis of a lens it is possible to correct misalignment of the laser beam with the optical axis of the lens during the lifetime of the spectrometer. This can allow for better and/or more consistent targeting of an input laser beam to a sample which can allow improved spectroscopy. By allowing for the correction of misalignment of the laser beam the spectrometer can be more resilient to vibration, or temperature variation, or other factors which can cause misalignment of the laser beam with the optical axis of the lens.

According to a second aspect of invention there is provided a method of monitoring alignment of a laser beam of a spectrometer with an optical axis of a lens of the spectrometer comprising using information relating to the location of a laser beam on a component and/or using information relating to a direction of the laser beam towards the component (i.e., the direction of the laser beam before reflection towards the lens) and/or the direction of the laser beam away from the component (i.e., the direction of the laser beam after reflection towards the lens) comprising moving a beam splitter and a laser beam path correction element to a position where the beam splitter and the laser path correction element are in the laser beam path from a position where the beam splitter and the laser path correction element are not in the laser beam path. Optionally the component is a component for directing the laser beam to the lens so as to be co-axial with the lens'. The method may comprise using part of the laser beam from the beam splitter to determine the location of a laser beam on the component and/or the direction of the laser beam towards and/or away from the component. The method optionally comprises adjusting the position of at least one beam path director to reduce misalignment of the laser beam with the optical axis of the lens based on the result of the monitoring.

According to a third aspect of invention there is provided a module for a spectrometer comprising a first sensor for detecting the position of a laser beam thereon, a second sensor for detecting the position of a laser beam thereon, and abeam splitter for directing at least part of a laser beam towards the first sensor and the second sensor, wherein the module comprises a laser beam path correction element. Optionally the beam splitter for directing the part of the laser beam towards the first and second sensors, and the laser path correction element are movable between a first position where the beam splitter for directing the part of the laser beam towards the first and second sensors, and the laser path correction element are in the path of the laser beam and a second position where the beam splitter for directing the part of the laser beam towards the first and second sensors, and the laser path correction element are not in the path of the laser beam. Optionally a second beam splitter is located between the beam splitter for directing at least part of a laser beam towards the first sensor and the second sensor and the first sensor and second sensor.

According to a fourth aspect of invention there is provided a processor configured to cause movement of a beam splitter and a laser beam path correction element into a laser beam path, and to receive a first input relating to the position of a laser beam, a second input relating to the position of the laser beam, wherein based on the first input and the second input the processor calculates parameters for reducing misalignment of the laser beam with a lens' optical axis.

The invention also provides a data carrier having instructions stored thereon, which, when executed by a processor, cause the processor to operate in accordance with the processor as defined in the fourth aspect of the invention.

The data carrier of the invention may be a suitable medium for providing a machine with instructions such as non-transient data carrier, for example a floppy disk, a CD ROM, a DVD ROM/RAM (including −R/−RW and +R/+RW), an HD DVD, a Blu Ray™ disc, a memory (such as a Memory Stick™), an SD card, a compact flash card, or the like), a disc drive (such as a hard disk drive), a tape, any magneto/optical storage, or a transient data carrier, such as a signal on a wire or fiber optic or a wireless signal, for example a signals sent over a wired or wireless network (such as an Internet download, an FTP transfer, or the like).

Also disclosed is a spectrometer. The spectrometer may comprise a laser for generating a laser beam. The spectrometer may comprise a lens for directing the laser beam to a location of a sample. The spectrometer may comprise a component for directing the laser beam to the lens optionally so as to be co-axial with the lens' optical axis. The spectrometer may comprise a beam splitter for directing the part of the laser beam towards a sensor. The spectrometer may be arranged such that part of the laser beam can be used for monitoring alignment of the laser beam with the lens' optical axis. The spectrometer may comprise a laser beam path correction element.

Features from one aspect of may be incorporated included in other aspects of invention.

The invention will now be described by way of example only and with reference to the following drawings in which:

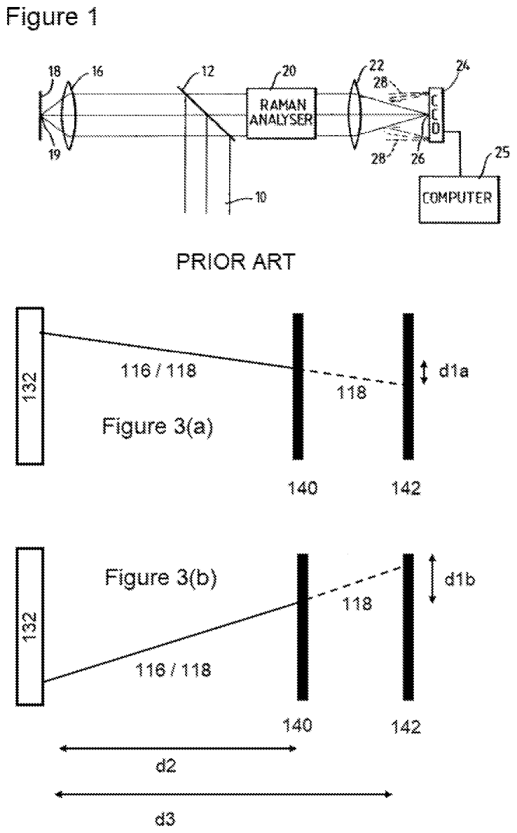

FIG. 1—illustrates a prior art spectrometer;

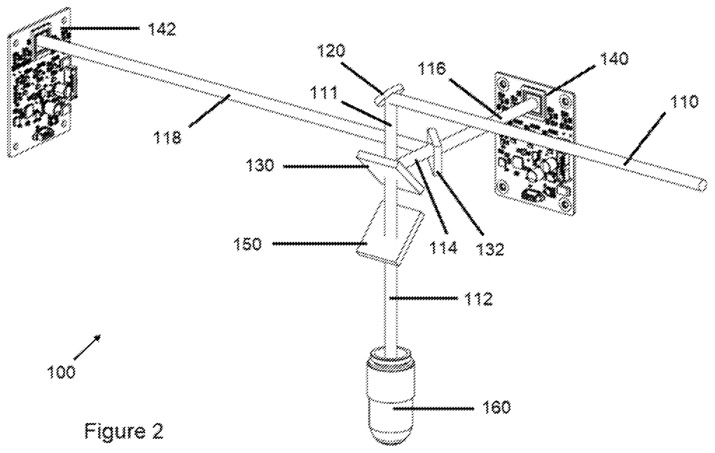

FIG. 2—illustrates part of a spectrometer according to the invention;

FIG. 3—schematically illustrates part of a laser beam path;

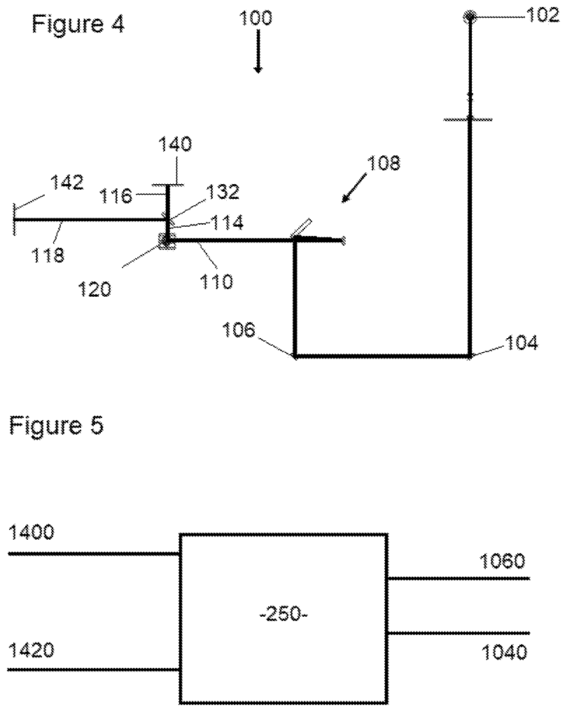

FIG. 4—schematically illustrates further features of the spectrometer of FIG. 2;

And

FIG. 5—shows a processor for receiving signals from the spectrometer according to the invention.

FIG. 1 shows a prior art spectrometer, in particular a Raman spectrometer. In the illustrated Raman spectrometer an input laser beam 10 is reflected through 90° by a dichroic filter 12 which has been placed at an angle of 45° to the optical path.

The path of the laser beam after reflection by the dichroic filter 12 is co-axial with the optical axis of a microscope objective lens 16. The laser beam 10 then passes to the microscope objective lens 16, which focuses the laser beam to a spot at a focal point 19 on a sample 18. Light is scattered by the sample at this illuminated spot and is collected by the microscope objective lens 16 and collimated into a parallel beam. The light passes to dichroic filter 12 which rejects Rayleigh scattered light (elastically scattered light having the same wavelength as the input laser beam 10). Dichroic filter 12 transmits Raman scattered light. The Raman scattered light then passes to a Raman analyser 20. The Raman analyser 20 may comprise a tuneable non-dispersive filter for selecting a Raman line of interest. Alternatively, the Raman analyser 20 may comprise a dispersive element such as a diffraction grating. Light from the Raman analyser 20 is focused by a lens 22 onto a suitable photodetector 24. In this example a CCD (charge coupled device) 24 is used which comprises a two-dimensional array of pixels, and which is connected to a computer 25 which acquires data from each of the pixels and analyses the data as required. Where the Raman analyser 20 comprises a tuneable non-dispersive filter, light of the selected Raman frequency is focused at point 26 on CCD 24. Where the Raman analyser 20 comprises a dispersive element (such as a diffraction grating), the analyser 20 produces a spectrum having various bands as indicated by broken lines 28 which are spread out along a line on the CCD 24.

While the example of a spectrometer illustrated in FIG. 1 shows a dichroic filter 12 as being an optical element which reflects the laser beam 10 so as to be co-axial with the optical axis of the microscope objective lens 16, this is only one example. A different component may be used to direct the laser beam so as to be co-axial with the optical axis of the microscope objective lens 16, for example a mirror or other optical component. Where a dichroic filter 12 is used, it may be advantageous for the laser beam 10 to be reflected through an angle other than 90°. In this case, after reflection by the dichroic filter 12 the laser beam 10 should be co-axial with the optical axis of the microscope objective lens 16 however the orientation of the dichroic filter 12 and the angle which the laser beam 10 approaches the dichroic filter 12 before reflection will be different.

It is known when manufacturing the spectrometer to align the laser beam with the dichroic filter 12 (or alternative component) such that the laser beam is co-axial with the optical axis of the microscope objective lens 16. However, it is possible after manufacture for the laser beam to become misaligned with the optical axis of the microscope objective lens. This could be due to vibration, mechanical wear of other (not illustrated) laser beam directing components, distortion of optical components due to heating from the laser beam or room, or for another reason.

FIG. 2 shows part of a Raman spectrometer 100 (other components of the spectrometer have been omitted for clarity) according to the invention. Similar to the prior art spectrometer illustrated in FIG. 1 the arrangement shown in FIG. 2 comprises a microscope objective lens which forms part of the microscope objective 160. The spectrometer also comprises a component 120 (in this embodiment a mirror 120) for directing a laser beam to the lens of the microscope objective 160 so as to be co-axial with the lens' optical axis. The mirror 120 of the embodiment of FIG. 2 has similarities with the dichroic filter 12 of FIG. 1 because both mirror 120 and dichroic filter 12 direct an input laser beam towards a lens of a microscope objective so as to be co-axial with the lens' optical axis.

FIG. 2 shows an input laser beam 110 directed towards mirror 120 which reflects the input laser beam 110 towards the lens of the microscope objective 160, the reflected laser beam shown as laser beam 111. Between the mirror 120 and the microscope objective is located a first beam splitter 130. The first beam splitter 130 splits the laser beam 111 into two parts, a first laser beam part 112 which continues towards the microscope objective 160 and a second laser beam part 114. The second laser beam part 114 can be used for monitoring alignment of the laser beam with the optical axis of the lens of the microscope objective 160. The second laser beam part 114 is directed towards a first sensor 140 which in this embodiment is a position sensitive detector. Between the first beam splitter 130 and the first sensor 140 is located a second beam splitter 132. The second beam splitter 132 splits the second laser beam part 114 into two parts, a laser beam part 116 which continues towards the first sensor 140 and a laser beam part 118 which is directed towards a second sensor 142. In this embodiment, the second sensor 142 is a position sensitive detector. The distance travelled by laser beam part 116 between the second beam splitter 132 and the first sensor 140 and the distance travelled by the laser beam part 118 between the second beam splitter 132 and the second sensor 142 are different. The different distances travelled by the laser beam parts 116, 118 between the second beam splitter 132 and the first and second sensors 140, 142 allows the position of the input laser beam 110 on the mirror 120 to be determined and also allows the direction of the laser beam 110 towards and/or the laser beam 111 away from the mirror 120 to be determined as explained in relation to FIG. 3 below.

First beam splitter 130 splits the laser beam 111 with a first laser beam part 112 being transmitted through the first beam splitter 130. As the laser beam enters the first beam splitter 130 the beam is refracted, travels through the first beam splitter 130 and is refracted a second time as the beam exits the first beam splitter 130. The resulting first laser beam part 112 upon exiting the first beam splitter 130 is parallel to the path of laser beam 111 but off-set from this path. In order to correct the beam off-set of laser beam part 112 a laser path correction element 150 is provided between the first beam splitter 130 and the microscope objective 160. In this embodiment the laser path correction element 150 corrects the path of laser beam part 112 by causing corresponding but opposite refractions to those which occur as the laser beam passes through the first beam splitter 130. The result is that the path of laser beam part 112 is restored to being co-axial with the path of laser beam 111. By providing a laser path correction element 150 the laser beam part 112 and the laser beam 111 have the same relationship to the optical axis of the lens of the microscope objective 160.

Part of the laser beam 111 is reflected by the first beam splitter 130 to direct second laser beam part 114 in a different direction to the direction of first laser beam part 112. By splitting the laser beam 111 into first laser beam part 112 and second laser beam part 114, the strength of first laser beam part 112 is reduced in comparison to laser beam 111. The strength of first laser beam part 112 in comparison to laser beam 111 can also be reduced due to losses associated with passing through the first beam splitter 130 and laser path correction element 150. The reduction in the strength of first laser part 112 compared with laser beam 111 can result in a reduction of Raman signal generated when the first laser beam part 112 interacts with a sample.

By providing a laser path correction element 150 the laser beam part 112 and the laser beam 111 have the same relationship to the optical axis of the lens of the microscope objective 160. This provides the current embodiment with the advantage that the first beam splitter 130 and the laser path correction element 150 can moved between a first position (as shown in FIG. 2) and a second position where the first beam splitter 130 and the laser path correction element 150 are removed from the path of laser beam 111 while maintaining the relationship the laser beam (or laser beam part) has with the lens of the microscope objective 160. This allows the first beam splitter 130 and laser path correction element 150 to be inserted into the beam to monitor the alignment of a laser beam with a lens'optical axis and the first beam splitter 130 and laser path correction element 150 to be removed between laser beam alignment monitoring events, this can allow the strength the Raman signal obtained from the sample between laser beam alignment monitoring events to be maximized.

FIG. 3 shows the laser beam parts 116, 118, second beam splitter 132, and first 140 and second 142 sensors. While the figure shows laser beam parts 116, 118 being coincident this is merely a schematic representation of the arrangement of these components corresponding to the arrangement of these components in FIG. 2.

In FIG. 3 it can be seen that the laser beam part 116 travels a distance d2 between the second beam splitter 132 and the first sensor 140, while the laser beam part 118 travels a different distance d3 (in this case a longer distance) between the second beam splitter 132 and the second sensor 142. As first 140 and second 142 sensors are position sensitive detectors, both the first sensor 140 and the second sensor 142 can detect the position on the respective sensor that laser beam parts 116, 118 fall. As can be seen from FIG. 3, because the distances d2, d3 between the second beam splitter 132 and the first 140 and second 142 sensors are different, it is possible to use the outputs of the first sensor 140 and the second sensor 142 to determine a distance d1. FIG. 3(a) shows a situation where d1 has a first value d1a, while FIG. 3(b) shows a second situation where d1 has a different value d1b. Using the value for d1 and the known difference between distances d2 and d3 it is possible to determine the direction of travel of each laser beam part 116, 118. Using the information on the direction of travel and either the position of the laser beam part 116 on the first sensor 140, or the position of the laser beam part 118 on the second sensor 142, it is possible to determine the position from which the laser beam parts 116, 118 leave the second beam splitter 132 and travel towards the first 140 and second 142 sensors. Further, it possible because of the known relationship between the sensors 140, 142, the first beam splitter 130 and mirror 120, to determine direction of travel of laser beam 111, and therefore the location of the laser beam 110 on mirror 120. The direction in which the laser beam 110 travels before being reflected by the mirror 120 can also be determined.

The information derived from the first sensor 140 and the second sensor 142 (for example the location of laser beam 110 on mirror 120 and the direction of travel of the laser beam 111) can be used to monitor the alignment of the laser beam 111 with the optical axis of the lens of the microscope objective 160.

FIG. 4 schematically shows as a plan view some further parts of the spectrometer 100. FIG. 4 shows a laser 102 for generating a laser beam 110. The path of laser beam 110 between laser 102 and mirror 120 is shown by the figure. From the laser 102 the laser beam follows a path to mirror 104. Mirror 104 is a movable mirror and can be moved in two degrees of freedom by a motor, in this embodiment mirror 104 can be rotated about an axis normal to the plane of FIG. 4 and/or rotated about an axis in the plane of the page and parallel the surface of the mirror. After reflection by mirror 104 the laser beam is directed towards mirror 106. Mirror 106 can be moved in two degrees of freedom by a motor, in this embodiment mirror 106 can be rotated about an axis normal to the plane of FIG. 4 and/or rotated about an axis in the plane of the page and parallel the surface of the mirror. Mirror 106 directs the laser beam to notch filter 108 from where the laser beam 110 is directed towards mirror 120. Mirror 120 directs the laser beam 110 (as laser beam 111 shown in FIG. 2) to first beam splitter 130 (not labelled but directly behind mirror 120 in FIG. 4). The first beam splitter 130 splits the laser beam as described in relation to FIG. 2, with FIG. 4 showing second laser beam part 114 being directed towards second beam splitter 132 and laser beam parts 116, 118 being directed towards first 140 and second 142 sensors.

In order to maintain the laser beam so as to be co-axial with the lens' optical axis, information from the first sensor 140 and second sensor 142 can be used to determine the position laser beam 110 on mirror 120, the position of laser beam 110 on the mirror 120 can then be altered based on the information from the first 140 and second 142 sensors by adjusting mirror 104 and/or mirror 106. Adjusting mirror 104 and/or mirror 106 can reduce the degree of misalignment of the laser beam 111 with the optical axis of the lens of the microscope objective 160. In addition to adjusting the position of the laser beam 110 on the mirror 120, the direction of the laser beam 110 towards mirror 120 and/or the direction of laser beam 111 away from the mirror 120 can be determined using information from the first 140 and second 142 sensors. The direction of the laser beam 110 towards the mirror 120 can be altered by adjusting mirror 104 and/or mirror 106 which alters the direction of laser beam 111 away from the mirror 120, this can reduce the degree of misalignment of the laser beam 111 with the optical axis of the lens of the microscope objective 160. In this embodiment both the location of the laser beam 110 and the direction of the laser beam 110 towards the mirror 120 may be adjusted together or may be adjusted separately (i.e., position of the laser beam 110 on the mirror 120 can be adjusted independently of adjustment of the direction of the laser beam 110 on the mirror 120).

FIG. 5 shows a controller 250. In this embodiment processor 250 forms part of a computer. In the current embodiment the computer can receive data from a CCD as is described in relation to computer 25 of the spectrometer shown in FIG. 1. In addition to the functions carried out by the computer 25 of FIG. 1, in the current application processor 250 is configured to receive a first input 1400 relating to the output of first sensor 140, and to receive a second input 1420 relating to the output of second sensor 142. The processor 250 can output a first signal 1060 and/or a second signal 1040 based on the first input 1400 and the second input 1420. The first signal 1040 relates to adjustment to be made to the orientation of mirror 104. The second signal 1060 relates to adjustment to be made to the orientation of mirror 106. In this embodiment the first signal 1040 and/or second signal 1060 are output to a controller configured to control the orientation of the first mirror 104 and/or the second mirror 106 via motors.

While an embodiment of the invention has been described in detail above, the invention is not limited to such an embodiment and other embodiments of the invention are possible. For example, in the above described embodiment a mirror 120 is used to direct the laser beam towards the lens of the microscope objective, in other embodiments this need not be the case and the laser beam could be directed towards the lens of a microscope objective by a dichroic filter (similar to the situation shown in the prior art FIG. 1), or any other optical element capable of directing the laser beam as needed. While an embodiment of the invention has been described using position sensitive detectors, in other embodiments other sensors capable of detecting the position of an input laser beam may be used, for example position quadrant detectors. In other embodiments the first beam splitter 130 and the laser path correction element 150 may be fixed in the path of the laser beam. While the invention has generally been described such that part of the laser beam can be used for monitoring alignment of the laser beam with the lens' optical axis after initial set up, in some embodiments part of the laser beam could be used during set up to align the laser beam with the lens' optical axis. In the above described embodiment, the first beam splitter 130 is located between mirror 120 (i.e., the component for directing the laser beam towards the lens of the microscope objective) and microscope objective 160, however in other embodiments the first beam splitter (and the laser path correction element 150 when present) may be located between the mirror 120 and the laser 102, in other words before the laser beam 110 has been directed towards the lens of the microscope objective by mirror 120. In these embodiments laser beam monitoring events occur separately to spectroscopy events.

1. A spectrometer comprising a laser for generating a laser beam, a lens for directing the laser beam to a location of a sample, and a component for directing the laser beam to the lens so as to be co-axial with the lens' optical axis, the spectrometer comprising a beam splitter for directing the part of the laser beam towards a sensor arranged such that part of the laser beam can be used for monitoring alignment of the laser beam with the lens' optical axis, and wherein the spectrometer comprises a laser beam path correction element.

2. A spectrometer as claimed in claim 1 wherein the beam splitter for directing the part of the laser beam towards a sensor can be moved between a first position where the beam splitter for directing the part of the laser beam towards a sensor is in the path of the laser beam and a second position where the beam splitter for directing the part of the laser beam towards a sensor is not in the path of the laser beam.

3. A spectrometer as claimed in claim 1 wherein the laser path correction element can be moved between a first position where the laser beam path correction element is in the path of the laser beam and a second position where the laser beam path correction element is not in the path of the laser beam.

4. A spectrometer as claimed in claim 1 comprising a second beam splitter for splitting the part of the laser beam such that a first part is directed towards the sensor and a second part is directed towards a second sensor.

5. A spectrometer as claimed in claim 4 wherein the path length of the laser beam between the component and the sensor, and pathlength of the laser beam between the component and the second sensor are different.

6. A spectrometer as claimed in claim 1 wherein monitoring alignment of the laser beam with the lens' optical axis comprises monitoring the location of the laser beam on the component.

7. A spectrometer as claimed in claim 1 wherein monitoring alignment of the laser beam with the lens' optical axis comprises monitoring the direction of the laser beam towards and/or away from the component.

8. A spectrometer as claimed in claim 1 configured to reduce misalignment of the laser beam with the lens' optical axis based on the monitoring.

9. A spectrometer as claimed in claim 8 comprising a first beam path director movable in two degrees of freedom, wherein the first beam path director is controlled to reduce misalignment of the laser beam with the lens' optical axis based on the monitoring.

10. A spectrometer as claimed in claim 9 comprising a second beam path director movable in two degrees of freedom, wherein the second beam path director is controlled to reduce misalignment of the laser beam with the lens' optical axis based on the monitoring.

11. A spectrometer as claimed in claim 10 wherein the first beam path director and/or the second beam path director comprises a mirror.

12. A method of monitoring alignment of a laser beam of a spectrometer with an optical axis of a lens of the spectrometer comprising using information relating to the location of a laser beam on a component and/or using information relating to a direction of the laser beam towards and/or away from the component, comprising moving a beam splitter and a laser beam path correction element to a position where the beam splitter and the laser path correction element are in the laser beam path from a position where the beam splitter and the laser path correction element are not in the laser beam path.

13. A method of monitoring alignment of a laser beam of a spectrometer as claimed in claim 12 comprising using part of the laser beam from the beam splitter to determine the location of a laser beam on the component and/or the direction of the laser beam towards and/or away from the component.

14. A method of monitoring alignment of a laser beam of a spectrometer as claimed in claim 12 comprising adjusting the position of at least one beam path director to reduce misalignment of the laser beam with the optical axis of the lens based on the result of the monitoring.

15. A module for a spectrometer comprising a first sensor for detecting the position of a laser beam thereon, a second sensor for detecting the position of a laser beam thereon, and abeam splitter for directing at least part of a laser beam towards the first sensor and the second sensor, wherein the module comprises a laser beam path correction element.

16. A processor configured to cause movement of a beam splitter and a laser beam path correction element into a laser beam path, and to receive a first input relating to the position of a laser beam, a second input relating to the position of the laser beam, wherein based on the first input and the second input the processor calculates parameters for reducing misalignment of the laser beam with a lens' optical axis.

17. A data carrier having instructions stored thereon, which, when executed by a processor, cause the processor to operate in accordance with the processor as defined in claim 16.
